(19) United States
(12) Patent Application Publication
(10) Pub. No.: US 2017/0286922 A1
(43) Pub. Date: Oct. 5, 2017

(54) VEHICLE TITLE TRANSFER AND LIEN PAYOFF

(71) Applicant: James A. Ledder, Prairie Grove, IL (US)

(72) Inventor: James A. Ledder, Prairie Grove, IL (US)

(73) Assignee: ALLSTATE INSURANCE COMPANY, Northbrook, IL (US)

(21) Appl. No.: 13/469,432

(22) Filed: May 11, 2012

(51) Int. Cl. G06Q 40/00

(52) U.S. Cl. CPC G06Q 14/025

(57) ABSTRACT

A title transfer and lien payoff system may communicate with various parties and perform functions associated with vehicle title transfer and lien payoff processes. A vehicle title transfer and lien payoff system may receive user and vehicle information from various parties, and may store lien payoff and title transfer records. The system may allow authorized users for various parties to perform functions based on the user's role and permissions, and based on the status of the lien payoff and title transfer processes for associated vehicles. After performing functions within these processes, the system may identify and initiate communications with one or more addition parties involved in the lien payoff and title transfer processes. Communication preferences may also be stored and applied for various parties and users within the title transfer and lien payoff system.

### BACKGROUND

When a vehicle is seriously damaged by an accident, severe weather, a natural disaster, criminal activity, or by one of many other causes, the vehicle may be “totaled” meaning that the cost needed to repair the vehicle is not justified by the vehicle's value. In such cases, the vehicle may undergo lien payoff and/or title transfer processes, during which an insurance claim is paid for the damaged vehicle, the vehicle is paid off and any liens on the vehicle are released, and the vehicle's title is transferred from the vehicle owner or lienholder to another party, such as a repair shop or salvage company.

Lien payoff and title transfer processes may involve coordination between many different parties, for example, insurance companies, vehicle owners, lienholders, title holders and title transferees, governmental entities, and other parties. These processes may be tedious and time consuming for all parties involved, requiring many different communications, negotiations, and agreements to occur between the parties before the vehicle's lien may be paid off and the title transferred. Miscommunications between the various parties (and internal miscommunications between members of the same company or organization), slow response times by certain parties, and incompatibilities between the different systems and communication techniques used by the parties, can cause errors and further delays within these processes. Such errors and delays may prevent the parties from quickly and efficiently resolving the lien payoff and title transfer processes, and may prevent the vehicle owner from quickly recovering an insurance claim payment and/or obtaining the financing necessary to purchase a new vehicle.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for communicating with parties and performing various functions associated with vehicle title transfer and/or lien payoff processes. For example, a title transfer and lien payoff system may be configured to receive information corresponding to one or more users and vehicles associated with title transfer and/or lien payoff processes. Based on the received information, the system may retrieve title transfer and lien payoff records for the associated vehicles. A system user may be authenticated as a first party authorized to perform functions associated with the title transfer and lien payoff processes for the associated vehicles. Lien payoff and title transfer functionality may be provided to the first party and one or more functions associated with the title transfer and/or lien payoff processes for the vehicles may be performed based on function requests of the first party. Additionally, data may be retrieved corresponding to a second authorized party, and communications may be initiated with the second party based on the functions performed for the title transfer and lien payoff processes.

According to additional aspects, a title transfer and lien payoff system may be configured to communicate with various different parties in the title transfer and lien payoff processes, for example, insurance companies, lienholders, vehicle owners, title holders, title transferees, and governmental entities, among others. Users associated with different parties may have different user roles and permissions within the system, and may be authorized to perform different subsets of functions within the title transfer and lien payoff processes. According to further aspects, the functions available to users of a title transfer and lien payoff system may be based on a current status of the title transfer and/or lien payoff processes for certain vehicles. Additional aspects relate to storing and applying communication preferences for various parties and users in the title transfer and lien payoff system.

Other features and advantages of the disclosure will be apparent from the additional description provided herein.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network environment and computing systems that may be used to implement aspects of the disclosure.

FIG. 2 is a block diagram illustrating a vehicle title transfer and lien payoff environment according to one or more aspects of the disclosure.

FIG. 3 is a flow diagram illustrating an example method of performing functions in a vehicle title transfer and lien payoff process according to one or more aspects of the disclosure.

FIGS. 4A and 4B illustrate examples of user interfaces of a title transfer and lien payoff application according to one or more aspects described herein.

FIG. 5 is a block diagram illustrating a vehicle title transfer and lien payoff environment according to one or more aspects of the disclosure

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

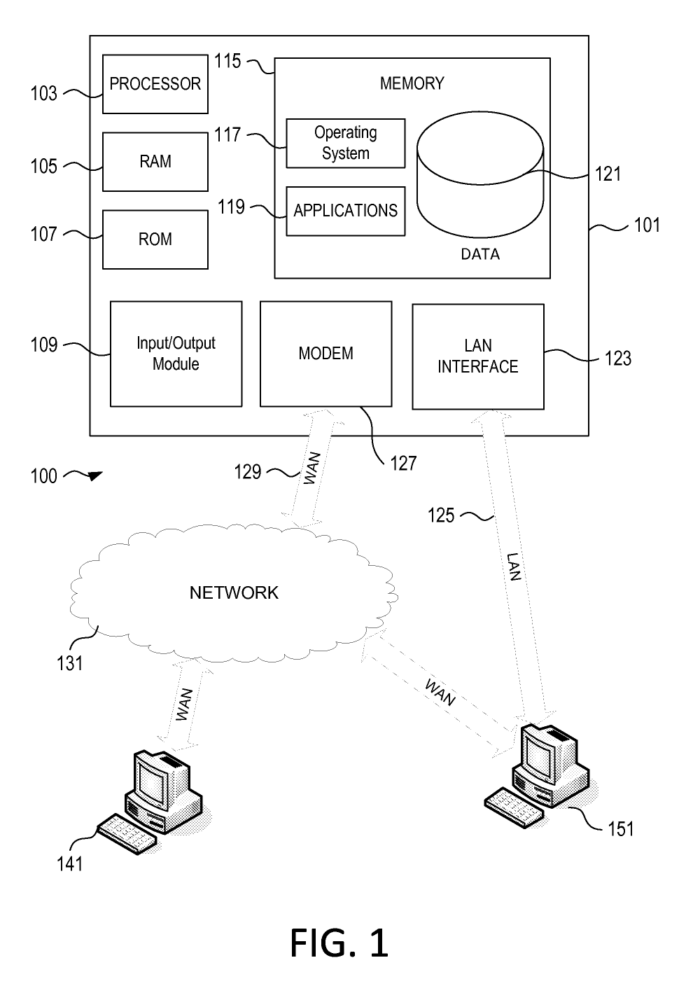

FIG. 1 illustrates a block diagram of a vehicle title transfer and lien payoff computing device 101 in communication system 100 that may be used according to one or more illustrative embodiments of the disclosure. The computing device 101 may correspond to any of multiple systems or devices including systems configured to perform and manage vehicle lien payoff processes and/or title transfer processes. The device 101 may have a processor 103 for controlling overall operation of the device 101 and its associated components, including RAM 105, ROM 107, input/output module 109, and memory 115.

Input/Output (I/O) 109 may include a microphone, keypad, touch screen, and/or stylus through which a user of a vehicle title transfer and lien payoff system 101 may provide input, and may also include one or more of a speaker for providing audio output and a video display device for providing textual, audiovisual and/or graphical output. Software may be stored within memory 115 and/or storage to provide instructions to processor 103 for enabling system 101 to perform various functions. For example, memory 115 may store software used by the device 101, such as an operating system 117, application programs 119, and an associated internal database 121. Processor 103 and its associated components may allow the system 101 to execute a series of computer-readable instructions to communicate with different parties in lien payoff and title transfer processes (e.g., vehicle owners, insurance providers, lienholders, etc.), and to perform and manage vehicle lien payoff and title transfer functions. In certain examples, the vehicle title transfer and lien payoff system 101, and/or one or more related computer systems 101, may store and maintain data relating to lien payoff and title transfer processes for vehicles and may coordinate communications among the various parties to more efficiently complete the lien payoff and title transfer processes.

The vehicle title transfer and lien payoff system 101 may operate in a networked environment supporting connections to one or more remote computers, such as terminals 141 and 151. The terminals 141 and 151 may be personal computers (e.g., personal computers of vehicle owners), servers (e.g., insurance provider and lienholder computer systems), mobile communication devices, portable computing devices, and the like that include many or all of the elements described above with respect to the vehicle title transfer and lien payoff system 101. The network connections depicted in FIG. 1 include a local area network (LAN) 125 and a wide area network (WAN) 129, but may also include other networks. When used in a LAN networking environment, the vehicle title transfer and lien payoff system 101 is connected to the LAN 125 through a network interface or adapter 123. When used in a WAN networking environment, the vehicle title transfer and lien payoff system 101 may include a modem 127 or other means for establishing communications over the WAN 129, such as network 131 (e.g., the Internet). It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the vehicle title transfer and lien payoff system 101 according to an illustrative embodiment of the disclosure may include computer executable instructions for receiving and managing communications from the various parties, and performing various functions within the vehicle title transfer and lien payoff processes. The application program 119, and/or one or more additional related application programs 119, also may include computer executable instructions for storing and retrieving vehicle title transfer and lien payoff records, storing and managing the communications and communication preferences of the various parties, and coordinating and performing functions for executing lien payoffs, insurance payouts, and title transfers, etc.

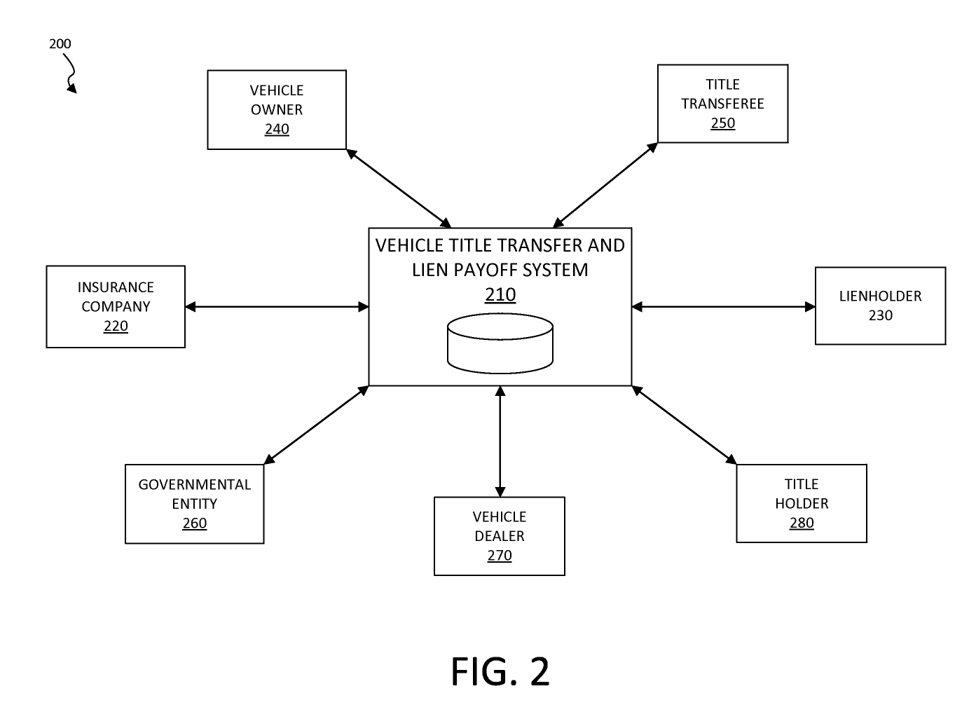

FIG. 2 is a block diagram illustrating an example vehicle title transfer and lien payoff environment 200 according to one or more aspects of the disclosure. In this example a vehicle title transfer and lien payoff system 210 may be configured to perform certain vehicle lien payoff and title transfer processes in coordination with one or more other parties including, for example, one or more insurance providers for the vehicle 220, one or more lienholders for the vehicle 230, one or more vehicle owners 240, one or more title transferees 250 and title holders 280 for the vehicle, one or more governmental entities, and one or more vehicle dealers 270. A lien payoff process refers to a set of functions related to submitting a payment to a vehicle lienholder 230 from a paying party (e.g., insurance company 220, vehicle owner 240, vehicle dealer 270, etc.) so that the lienholder 230 may release a lien on the vehicle. A title transfer process refers to a set of functions related to transferring a vehicle's title (e.g., a paper or electronic title) from a title holder 280 (e.g., title clearing house) to a title transferee 250. As described in detail below, the vehicle title transfer and lien payoff system 210 may interact with various parties 220-280 to coordinate and/or perform a lien payoff and title transfer processes for various vehicles. As used herein, the term vehicle lien payoff and title transfer process may refer to an individual lien payoff process, an individual title transfer process, or a combination vehicle lien payoff and title transfer process.

As described below, certain title transfer and lien payoff processes and scenarios may involve certain parties 220-280 but not others. Additionally, certain organizational entities (e.g., insurance companies, financial institutions, vehicle dealers, etc.) may perform multiple roles in different scenarios. For example, a title clearing house might not be used in some cases, and a lienholder 230 (e.g., a financial institution) may be the title holder 280 for some vehicles. Additionally, a vehicle dealer 270 may provide financing to its customers 240, and thus may be the lienholder 230 and/or title holder 280 as well. In other examples, an insurance company 220, vehicle owner 240, or vehicle dealer 270 may become the title transferee 250 after submitting payment to the lienholder 230.

The following example scenario illustrates certain aspects and features of vehicle lien payoff and title transfer processes involving the system 210 and parties 220-280. In this example, a vehicle (e.g., car, motorcycle, boat, etc.) may sustain significant damage in an accident or natural disaster, and the vehicle owner 240 may initiate the process by informing the insurance company 220 that the vehicle has been damaged. The insurance company 220 may review the damage and determine that the vehicle is “totaled,” for example, that the cost to repair the vehicle is not justified by the value of the vehicle. After this determination, the insurance company 220 may learn that a lienholder 230 has a lien on the vehicle for a certain amount, and may pay an insurance claim on the vehicle to one or both of the lienholder 230 and the vehicle owner 240. For example, if the insurance claim on the totaled vehicle is for $5,000, and the lien on the vehicle is for $1,500, then the insurance company 220 may satisfy the insurance claim by paying $1,500 to the lienholder 230 and the remaining $3,500 to the vehicle owner 240. After receiving the payment, the lienholder 230 may release the lien, and the insurance company 220 may instruct the lienholder 230 to transfer the physical title to a title transferee 250 (e.g., a salvage company) to which the insurance company 220 has agreed to the sell the vehicle. The lienholder 230 may then instruct a separate title holding entity 280 (e.g., an escrow and title service company) to transfer a physical or electronic vehicle title to the selected title transferee 250. One or more times before, during, and/or after transferring these processes, the parties 220-280 may interact with one or more governmental entities 260 (e.g., state department of motor vehicles (DMV) databases, etc.), for example, to verify the accuracy and validity of the existing title information (e.g., vehicle owner and lienholder names, vehicle information, etc.), or to register the title transfer into a government record database. Also, during this process the vehicle owner 240 may purchase another vehicle, for example, from a vehicle dealer 270. In order to purchase the new vehicle, the vehicle owner 240 may attempt to obtain financing from the vehicle dealer 270, the owner's previous lienholder 230, or from another financial institution. In these examples, the vehicle owner 240, vehicle dealer 270, financial institution or new lienholder, and/or one or more other parties might need to communicate with the insurance company 220, the owner's previous lienholder 230, and other parties 240-280 to confirm that the vehicle owner's previous lien has been released and that the title to the owner's previous vehicle has been properly transferred.

Although the above example describes a scenario in which a vehicle is totaled and an insurance claim on the vehicle is paid to release a lien and the transfer the vehicle's title, the parties 210-280 in vehicle lien payoff and title transfer environment 200 may be involved in other types of lien payoff and title transfers processes as well. For example, lien payoffs and/or title transfers need not occur only for damaged vehicles, but may also occur when vehicle owners 240 payoff loans, refinance, sell, or trade-in their vehicles.

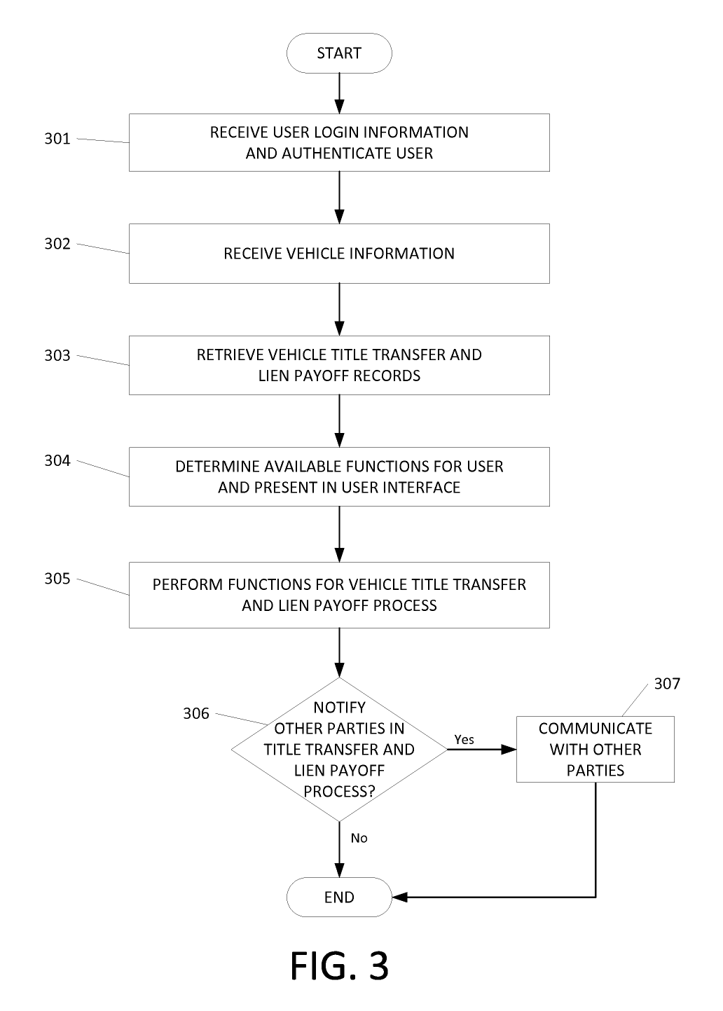

As illustrated in FIG. 2, a vehicle title transfer and lien payoff system 210 may communicate with some or all of the parties 220-280 to identify, coordinate, and perform the functions of the vehicle lien payoff and title transfer processes as described in the above examples. In certain examples, the system 210 may manage and control the vehicle title transfer and lien payoff processes by serving as an intermediary between the various parties 220-280 to direct and coordinate the functions performed by the parties 220-280. For instance, after a vehicle has been involved in an accident, the vehicle owner 240 and/or insurance company 230 might not have information readily available to identify to lienholder 230 or to determine the lien amount and other release conditions. In this example, the vehicle owner 240 and/or insurance company 230 may communicate with the vehicle title transfer and lien payoff system 210, and the system 210 may identify and initiate communication with the lienholder 230 to negotiate and coordinate the lien payoff process between the lienholder 230 and the vehicle owner 240 and/or insurance company 230. Additionally, when one of the parties 220-280 performs an action related to a vehicle title transfer and lien payoff process, the system 210 may provide status updates or notifications to the other relevant parties in the process. The system 210 may also directly perform one or more of the functions involved in these processes, for example, receiving and submitting payments (e.g., insurance claims, lien payoffs, etc.) and transferring electronic vehicle titles and other information to various parties 220-280. Additional examples of functions coordinated, directed, and/or performed by the vehicle title transfer and lien payoff system 210 are described below in reference to FIG. 3.

In certain examples, the vehicle title transfer and lien payoff system 210 may be implemented as a combination of hardware and software components at a central hub location, as shown in FIG. 2. In other examples, the system 210 may be operated by one of the parties 220-280 in the vehicle title transfer and lien payoff environment 200. For example, an insurance company 220 or lienholder 230 may host a vehicle title transfer and lien payoff server 210 as a separate or integrated component within one or more existing computer systems at the party's physical location. Additionally, the system 210 may be implemented as a combination of separate components at different locations within the environment 200, for example, as client-server computer applications in which various client components of the system 210 operate on the computer systems 101 of the various parties 220-280, and are configured to communicate with one or more server components of the system 210 operating in a central server hub. In the above examples, the system 210 and other parties 220-280 in the vehicle title transfer and lien payoff environment 200 may be configured to communicate over one or more computer networks (e.g., a LAN or WAN, the Internet, etc.) as well as other communication networks over various media (e.g., telephone networks, wireless networks, cable networks, satellite networks, etc.).

Referring now to FIG. 3, a flow diagram is shown illustrating an example method of performing one or more functions in a vehicle title transfer and lien payoff process according to one or more aspects of the disclosure. In this example, the steps described in FIG. 3 may be performed by a vehicle title transfer and lien payoff system 210 in communication with one or more of the other parties 220-280 in a title transfer and lien payoff environment 200. However, in other examples, certain steps in FIG. 3 and/or additional functions might not be performed by the system 210, but may be performed by one or more of the other parties 220-280 in the title transfer and lien payoff environment 200.

In step 301, a vehicle title transfer and lien payoff system 210 receives login information from a party associated with a title transfer and lien payoff process. In this step, the system 210 may provide a login user interface, for example, a login screen in a web-based or standalone client application. In certain examples, the login screen may be publicly available to existing users of the system 210, and may allow new users to register for the system. User credentials may be stored in a secure database or other storage maintained by the vehicle title transfer and lien payoff system 210. When the user provides the login information (e.g., a user identifier and password), the system 210 may verify the user's credentials to confirm that the user is authorized to perform at least certain functions within the system 210.

Additionally, in step 301 the system 210 may identify one or more user roles associated the authorized user, the user roles corresponding to one or more of the parties 220-280 for a vehicle lien payoff and title transfer process. As described below, the user's assigned roles may determine the user's permissions and the set of functions that the user is authorized to perform for the lien payoff and title transfer processes for any associated vehicles. For example, certain users such as a representative of a title holding entity 280, or a governmental employee at a state department of motor vehicles (DMV) 260, may have limited permissions and might only be permitted to view and input basic information relevant to those parties (e.g., the legal name on the vehicle title, the title transferee address, etc.), whereas other users such as the vehicle owner 240, insurance company 220, and lienholder 230 may have additional permissions within the system 210 to communicate and negotiate with other parties, provide instructions to the other parties, make payments and perform title transfers, and the like.

In step 302, the vehicle title transfer and lien payoff system 210 receives vehicle information for one or more vehicles in a title transfer and lien payoff process. For example, after the user has been authenticated in step 301, the system 210 may provide a user interface screen (e.g., web page or console application screen) prompting the authenticated user to enter one or more pieces of vehicle information. The vehicle information entered by the user and received by the system 210 in step 302 may include information describing a vehicle itself (e.g., a vehicle identification number (VIN), license plate number), and/or may include information corresponding a vehicle owner, insurance provider, lienholder, or other party associated with the vehicle.

As described below in more detail, the vehicle information received by the system 210 in step 302 may correspond to existing title transfer and lien payoff processes, or may be a request to initiate a new title transfer and lien payoff process. For example, a lienholder user 230 may login and enter a VIN or other vehicle information in step 302 to retrieve the records for an in-progress lien payoff and title transfer process that was previously initiated by a vehicle owner 240 or insurance company 220. In another example, a user (e.g., insurance company 220, lienholder 230, or vehicle owner 240) may enter vehicle data that does not correspond to any existing lien payoff or title transfer process stored in the system 210, and may instruct the system 210 to create a new record and initiate a new lien payoff and title transfer process based on the provided vehicle information.

In certain embodiments, step 302 may be optional and/or may be combined with step 301. For example, the vehicle title transfer and lien payoff system 210 may be configured to store a set of vehicles associated with each user, and may retrieve the set of associated vehicles in response to a successful user login in step 301. Thus, after logging in a user may be presented with a list of title transfer and lien payoff records for any vehicles in the system 210 that are associated with the user.

In step 303, the vehicle title transfer and lien payoff system 210 retrieves one or more title transfer records and lien payoff records based on the authorized user and the vehicle information received in steps 301 and 302. In order to identify one or more vehicles using the vehicle information entered in step 302, the system 210 and/or one or more of the parties 220-80, may maintain a database or other storage in which vehicle information is associated with vehicle owners, insurance providers, lienholders, and other parties. For example, if a user entering data in step 302 (e.g., a vehicle owner 240 or an insurance agent 220) does not have the vehicle's VIN or license plate number readily available, the user may be permitted to enter other information such as the vehicle owner's name and address, an insurance provider name and account number, a lienholder name and account number, or other information associated with one or more vehicles. Then, in step 303, the system 210 may identify any vehicles matching the data entered by the user in step 302, and may retrieve any title transfer and lien payoff process records associated with those vehicles.

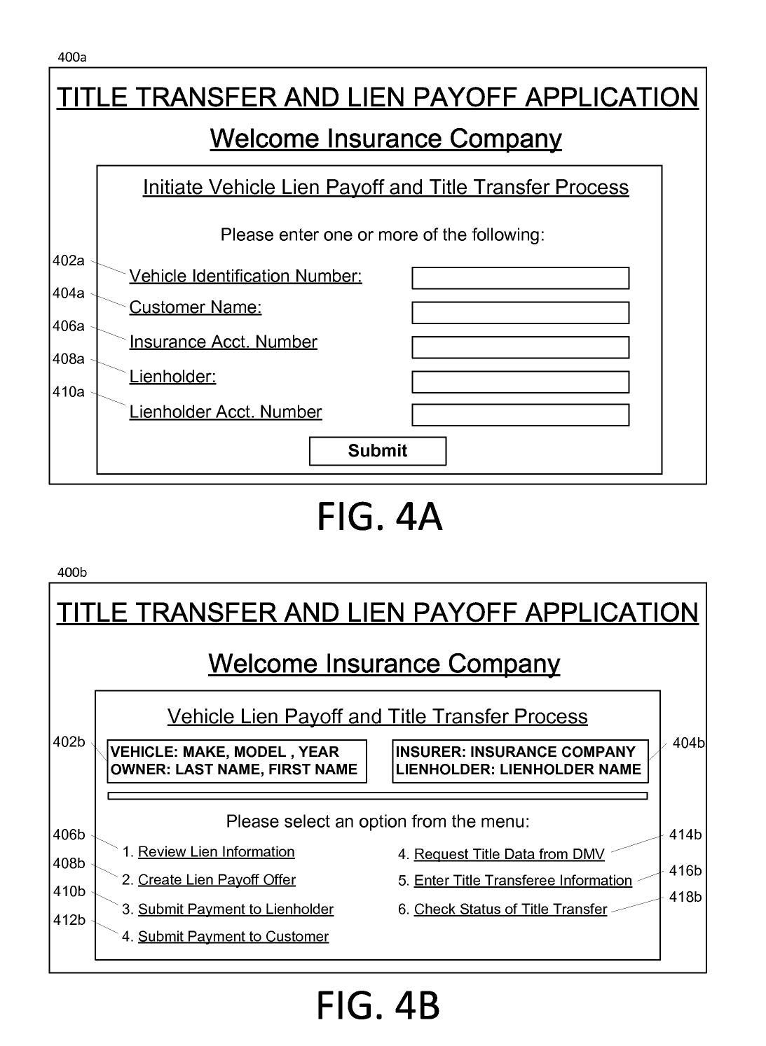

Referring briefly to FIG. 4A, an example user interface screen 400a is shown in a title transfer and lien payoff client application. In this example, an authorized user has logged into the system 210 and has been identified as a representative of an insurance company 220 (step 301). In screen 400a, the insurance company user (e.g., insurance agent, claims adjuster, etc.) is prompted to enter identifying information for one or more vehicles associated with a lien payoff and title transfer process. As discussed above, the insurance company user may input one or more pieces of available information, including a VIN 402a, customer name 404a, insurance account number 406a, lienholder name 408a, and/or lienholder account number 410a (step 302). After the user enters data into one or more input fields 402a-410a and submits the form, the system 210 may query a database or other storage to retrieve a set of vehicles corresponding to the submitted data (step 303). For instance, if the user inputs a single VIN into input box 402a, the system 210 may query one or more VIN database tables and may retrieve data (e.g., owner data, insurance data, lienholder data, etc.) corresponding to that vehicle. As another example, if the user inputs a lienholder name into the input box 408a, the system 210 may query an insurance-lienholder database table and may retrieve vehicle data corresponding to every vehicle insured by the user's insurance company which has a lien from that lienholder.

In certain embodiments, the title transfer and lien payoff records retrieved by the system 210 may be based on both the vehicle information received in step 302 and a set of user roles and permissions associated with the user authorized in step 301. For example, a user may input a valid VIN for a vehicle involved in a lien payoff and title transfer process, but the corresponding lien payoff and title transfer records might not be retrieved in step 303 if the system 210 determines that the user does not have the necessary permissions to view or update the records for that vehicle. The system 210 may define and store different roles and permissions associated different users and different vehicles. As an example, a first lienholder 230 may be granted permissions by the system 210 to retrieve, view, and update the lien payoff and title transfer records on vehicles for which a lien is held by the first lienholder 230, however, the first lienholder 230 may have limited permissions or no permissions to view or update other lien payoff and title transfer records for other vehicles. For instance, the system 210 may permit the first lienholder 230 only to view the lien status (e.g., in-force or released) for a different lien held by a second lienholder, so that the first lienholder 230 may determine whether or not to approve a loan application by the same vehicle owner 240 for a new vehicle. Similarly, if a vehicle owner's 240 car was recently totaled, and the owner 240 attempts to buy a new car from a car dealer 270, the system 210 may permit the dealer 270 to login and determine whether or not an insurance claim has been paid for the owner's previous car, and whether or not the lien on the owner's previous car has been released. However, the system 210 might not permit the dealer 270 to update any of the lien payoff or title transfer records, and might not permit the dealer 270 to view the other parties' information or any confidential records for the lien payoff or title transfer process.

Additionally, as discussed above, a user (e.g., insurance company 220, lienholder 230, or vehicle owner 240) may enter vehicle data in step 302 that does not correspond to any existing lien payoff or title transfer process. In this case, since title transfer and lien payoff records cannot be retrieved in step 303, the title transfer and lien payoff system 210 may use to vehicle information entered in step 302, along with the user roles and permissions of the user authorized in step 301, to initiate a new title transfer and/or lien payoff process. For example, referring again to FIG. 4A, if the insurance company user 220 enters a valid VIN 402a and submits the form 400a, the system 210 may determine from its internal databases that no lien payoff or title transfer processes are currently pending for the vehicle. In this case, the system may then confirm using its internal databases and/or one or more external databases (e.g., insurance provider database, governmental motor vehicle record databases, etc.) that the insurance company 220 has an insurance policy on the vehicle. If the insurance company 220 has a policy on the vehicle, the system 210 may provide the insurance company user with an interface to initiate a new title transfer and lien payoff process for the vehicle in the system 210. To initiate a new title transfer and/or lien payoff process, the user may enter certain vehicle information (e.g., VIN, license plate, make, model, car, value, damage report, etc.), insurance information (e.g., insurance provider, insurance account number, coverage, deductible, etc.), lien information (e.g., lienholder, loan account number, lien balance, lien conditions, etc.), and other relevant information. In certain embodiments, the system 210 may permit vehicle owners 240, insurance companies 220, and/or lienholders 230 to initiate vehicle lien payoff and title transfer processes.

In step 304, the vehicle title transfer and lien payoff system 210 may determine and present a user interface with a set of functions available to the user relating to the vehicle title transfer and lien payoff records retrieved in step 303, and in step 305 the system 210 may perform the functions selected by the user. As discussed above, both the records retrieved (step 303) and the set of available functions presented by the system 210 (step 304) may depend on the user's role and permissions for title transfer and lien payoff processes for certain vehicles. For example, a vehicle owner 240, title transferee 250, governmental entity 260, and vehicle dealer 270 may be permitted to retrieve and view the status of a vehicle lien payoff and title transfer process, but users in these roles might not be permitted to update the lien payoff and title transfer records in the system 210. In contrast, an insurance company user 220 and/or a lienholder user 230 may be able to view the status and update the lien payoff and title transfer records for the same vehicles. Moreover, the available set of functions presented by the system 210 may depend on the current state of the title transfer and lien payoff processes for the vehicles. For example, in certain embodiments the system 210 might not permit a lienholder 230 to release a lien on a vehicle or transfer the vehicle's title, until a lien payment has been submitted by the insurance provider 220 or vehicle owner 240, and/or until the validity of the vehicle title data has been confirmed by the vehicle owner 240 or a government entity 260 (e.g., DMV).

Referring now to FIG. 4B, a second example user interface screen 400b is shown in a title transfer and lien payoff client application. In this example, the authorized insurance company user in FIG. 4A has provided vehicle information corresponding to a single vehicle with a currently pending lien payoff and title transfer process in the system 210. After receiving the vehicle information from the user (e.g., VIN, vehicle owner's name, etc.), the system 210 has retrieved and displayed information for the title transfer and lien payoff process for the vehicle, including the vehicle and owner information 402b, and the insurance provider and lienholder information 404b. Additionally, the user interface screen 400b presents a set of functions 406b-418b which are available to be performed by the insurance company user within the vehicle lien payoff and title transfer process. In this example, the insurance company user may have the options of performing one or more of: reviewing the lien information for the vehicle 406b, creating a lien payoff offer to be provided to the lienholder 408b, submitting a payment to the lienholder 410b, submitting a payment to the vehicle owner 412b, requesting vehicle title data from the DMV 414b, entering title transferee information 416b, or checking the status of the title transfer process 418b. The system 210 may configure one or more of the options 406b-406b to be active or inactive depending on the current state of the lien payoff and title transfer process for the vehicle. For instance, user interface screens (e.g., 400b) in title transfer and lien payoff applications may be dynamically generated so that options unavailable to the user, or inapplicable for the current state of a vehicle lien payoff and title transfer process, do not appear in the user interface screen 400b are or inactive (e.g., greyed out) and cannot be selected by the user.

In step 305, the user may interact with one or more user interfaces provided by the system 210 to perform an available function within the lien payoff and title transfer process. The system 210 may provide one or more client applications (e.g., web-based application or standalone client console application) to receive selections from various users of different user roles, and may include the underlying functionality to perform the selected functions, for example, retrieving and updating lien payoff and title transfer records maintained in a system database or other storage, initiating communications and transmitting notifications to the various parties 220-280, receiving and transmitting electronic payments and electronic vehicle titles, and other functions related to the vehicle lien payoff and title transfer process.

While performing a lien payoff and title transfer function for a first party in step 305, the system 210 also may determine in step 306 whether or not one or more other parties 220-280 should receive notifications of the function and/or whether other communications should be initiated. If the system 210 determines that one or more parties 220-280 should be notified that the user performed a function or that an event occurred in the lien payoff and title transfer process (306:Yes), then in step 307 the system 210 may determine one or more communication techniques (or communication methods) for communicating with the second determined one or more parties 220-280 (e.g., email, phone, SMS messages, instant messaging (IM), etc.), and then initiate communication with the determined one or more parties 220-280. For example, when an insurance company 220, lienholder 230, or vehicle owner 240 uses the system 210 to submit a lien payoff offer, the system 210 may be configured to provide an email notification to the other parties involved in the lien payoff negotiation process. Additionally, when the lienholder 230 releases a lien on a vehicle, the system 210 may provide notifications to one or more other parties (e.g., the vehicle owner 240, a governmental entity 260, a vehicle dealer 270, the title holder 280 and/or title transferee 250, etc.).

As discussed above, the set of functions presented to users for various the parties 220-280 in step 304, and performed by the parties and the system 210 in step 305, may depend on the user roles and permissions of the user for the vehicle title transfer and lien payoff process. The following paragraphs include illustrative descriptions and examples of various types of functions that the system 210 may make available for different user roles, corresponding to the parties 220-280, within one or more title transfer and lien payoff processes. For each of the functions described below for the various different parties 220-280, the system 210 may provide one or more user interfaces to support communications with the parties 220-280, as well as the underlying functionality to perform the functions selected by the users.

Insurance Company 220

For an insurance company user (e.g., insurance agent, claims adjuster, or other insurance company employee), the system 210 may provide functions and user interfaces that allow the insurance company 220 to receive information from the vehicle owner 240 or other user indicating that an accident or other damage has occurred to a vehicle. For example, an insurance company registered with the system 210 may receive a notification (e.g., via email, SMS, etc.) that a vehicle owner 240 has created an accident report in the system 210, or that another party 220-280 has initiated a lien payoff and title transfer process for a vehicle insured by the insurance company 220. After the insurance company 220 has determined that a lien payoff and/or title transfer process should be initiated for the vehicle, the system 210 may provide functions and user interfaces to allow the insurance company 220 to create new vehicle lien payoff and title transfer process within the system 210 and input data relating to the vehicle, owner 240, insurance company 220, lienholder 230, etc. The system 210 may receive some information from the insurance company user, and may retrieve additional information from an internal database maintained by the system 210, from the other parties 220-280, and/or from other external sources, and then may create the initial records for the vehicle lien payoff and title transfer process in the system database or other storage.

After the lien payoff and title transfer processes have been initiated, the system 210 may provide functions and user interfaces that allow the insurance company 220 to update the insurance claim status for the vehicle (e.g., damage amount, claim payment amount, claim payment date, etc.), and to submit lien payoff offers to the lienholder 230. For example, a system user interface may allow an insurance company user to enter a lien payoff offer indicating that the insurance company 220 is willing to pay the outstanding lien amount in exchange for the lienholder 230 agreeing to transfer the vehicle's title to a title transferee 250 selected by the insurance company 220. In other examples, the system 210 may allow the insurance company 220 to offer less the outstanding lien amount, for instance, if the insurance claim payout amount is less than the lien amount. The system 210 may also allow the insurance company 220 to receive and respond to lien payoff offers and counteroffers from lienholders 230. For example, if an initial lien payoff offer from the insurance company 220 is less than the lien amount, the lienholder 230 might reject the offer and submit a counteroffer to the insurance company 220 via the system 210. The system to 210 may notify the insurance company 220 upon receiving an offer or counteroffer, and may provide user interfaces to allow the insurance company 200 to review, accept or reject, and/or submit another lien payoff counteroffer to the lienholder 230. Thus, the system 210 may be configured to support lien payoff negotiations between one or more insurance companies 220, lienholders 230, and/or additional parties (e.g., the vehicle owner 240, vehicle dealer 270, etc.), by receiving, storing, forwarding, and tracking offers and counteroffers from the various parties 220-280.

After a lien payoff offer has been agreed to by the relevant parties (e.g., insurance company 220, lienholder 230, vehicle owner 240), the system 210 may provide functions and user interfaces that allow the insurance company 220 to submit insurance claim payments to lienholders 230 and/or vehicle owners 240. For example, the system 210 may accept an electronic payment from an insurance company 220 corresponding to the vehicle insurance claim, and then may generate and transmit a corresponding electronic payment to the lienholder 230 to release the lien on the vehicle. The system 210 may also transmit an additional electronic payment with any remaining balance to the vehicle owner 240. In other examples, the system 210 might not directly receive and submit electronic payments from the parties 220-280, but may allow users to record payments that they have sent or received (e.g., via paper check, electronic funds transfer, etc.). In these examples, the system 210 may provide a user interface to allow the insurance company 220 and/or other parties 230-280 to record payments sent or received (e.g., amount, date, to and from), and may store the payment records, track payments, confirm payments have been received, and notify one or more other parties 220-280 when payments are sent or received.

The system 210 may also provide functions and user interfaces to allow insurance companies 220 to check on the status of lien payoff and title transfer processes, to input a title transferee 250 (e.g., transferee legal name, address, etc.), and to send messages and notifications to other parties 220-280. For example, if a lienholder 230 has not responded to a lien payoff offer submitted by an insurance company 220, the system 210 may automatically remind the lienholder 230 of the pending offer after a predetermined amount of time, or may allow the insurance company 220 to send a follow-up message to the lienholder 230. The system 210 may also allow the insurance company 220 to contact a governmental entity 260 (e.g., state motor vehicle department personnel or an automated DMV record system) to determine an accurate legal name on the vehicle title and/or other vehicle information. Additionally, the system 210 may allow the insurance company 220 to login and confirm that a vehicle title (e.g., physical or electronic title) has been send by the title holder 280 and/or received by the title transferee 250.

Lienholder 230

For a lienholder user (e.g., lienholder agent, loan officer, or other financial institution employee), the system 210 may provide functions and user interfaces that allow the lienholder 230 to receive information about a lien payoff and title transfer process for a vehicle having a lien held by the lienholder 230. For example, the system 210 may be configured to notify the lienholder 230 in response to a vehicle accident report created by an insurance company 220, vehicle owner 240, or other party. After the system 210 receives an indication that a lien payoff or title transfer process has been initiated, the system 210 may retrieve information from an internal system database or other source (e.g., lienholder database, governmental record database) to identify one or more lienholders 230 for the vehicle, and may notify the lienholders 230. After notifying the lienholder 230 of the vehicle lien payoff and title transfer process, the system 210 may provide functions and user interfaces to allow the lienholder 230 to enter information regarding the vehicle's liens, such as the number of liens, lien amounts due, and any other conditions that must be satisfied for the release of the liens on the vehicle.

As described above for insurance companies 220, the vehicle title transfer and lien payoff system 210 may provide functions and user interfaces to allow lienholders 230 to receive lien payoff offers from insurance companies 220, vehicle owners 240, new vehicle dealers 270, and/or other parties 22-280. The system 210 may provide notifications to lienholders 230 to indicate that a lien payoff offer has been submitted, and may provide one or more user interfaces to allow the lienholder 230 to review the offer, accept or reject the offer, and/or submit a counteroffer. For example, if a lien payoff offer submitted by an insurance company 220 is less than the lien amount due, the system 210 may allow the lienholder 230 to review the offer and submit a counteroffer to the insurance company 220 and/or the vehicle owner 240, in which the lienholder 230 will agree to accept the insurance company's 220 offer on the condition that the owner 240 uses the lienholder 230 again when purchasing a new vehicle to replace the owner's previous vehicle.

As described above for insurance companies 220, the system 210 may also allow lienholders 230 to receive electronic payments from and submit electronic payments to insurance companies 220, vehicle owners 240, and other parties 220-280. Additionally, as described above, rather than receiving and transmitting electronic funds directly, the system 210 may provide functions and user interfaces for lienholders 230 and other users 220-280 to record payments that have been sent or received (e.g., amount, date, payer, payee, etc.), and the system 210 may store the payment records, track the payments, and notify one or more other parties 220-280 of payments that have been sent or received.

After a lien payoff agreement has been reached by the parties, the system 210 may provide functions and user interfaces to allow the lienholder 230 to release the vehicle lien and update one or more lien payoff records in the system 210 to indicate that the lien has been released. After the lienholder 230 has released the lien, the system 210 may send notifications to one or more other parties, for example, the insurance company 220, the vehicle owner 240, and the title holder 280, to indicate that the lien has been released.

The system 210 may also provide functions and user interfaces to allow lienholders 230 to transfer vehicle titles to designated title transferees 250. In certain examples, the insurance provider 220, vehicle owner 240, or other party 220-280 may input title transferee information (e.g., transferee name, address, etc.) into the system 210, and the system 210 may transmit a notification to lienholder 230 including the title transferee information and/or may allow the lienholder to login into the system 210 to review the title transferee information 250 and transfer the vehicle title. If a lienholder 230 is also the title holder 280 for a vehicle title, then the lienholder 230 may perform the transfer directly by transmitting an electronic vehicle title or mailing a paper vehicle title to the title transferee 250. If the lienholder 230 is not the title holder 280, the system 210 may provide a user interface allowing the lienholder 230 to instruct the title holder 280, and may also notify the title holder 280 that instructions have been provided by the lienholder 230 to transfer the vehicle title. After the vehicle title has been transferred, the system 210 may allow the lienholder 230 and/or title holder 280 to update a lien payoff and title transfer record indicating that the vehicle title has been transferred.

Vehicle Owner 240

For a vehicle owner 240, the system 210 may provide functions and user interfaces to allow the owner 240 create an accident report for a vehicle and/or initiate a lien payoff and title transfer process. For example, if the owner's vehicle is damaged due to an accident or other occurrence, the vehicle owner 240 may login to the system 210 to inform the owner's insurance company 220 and/or lienholder 230, rather than contacting the insurance company 220 through other means (e.g., phone, in-person). If a vehicle owner 240 enters an accident report into the system 210, the system 210 may send a notification to the insurance company 220 and/or the lienholder 230 reporting the accident. In certain examples, the title transfer and lien payoff system 210 may require the insurance company 220 to initiate a lien payoff and title transfer process only after it determines that the vehicle has been totaled. In other examples, the system 210 may allow the vehicle owner 240 to initiate a lien payoff and title transfer process for the owner's vehicle. Additionally, the system 210 may allow the vehicle owner 240 to initiate a lien payoff and title transfer process for a vehicle that has not been damaged, for example, to allow the owner 240 to directly pay off a lien or refinancing a vehicle using a different lienholder 230.

As described above for insurance companies 220 and lienholders 230, the system 210 may be configured to allow vehicle owners 240 to participate in the lien payoff negotiation process. Thus, in some examples, the system 210 may provide similar functions and user interfaces to allow vehicle owners 240 to submit and review lien payoff offers, accept or reject offers, and make counteroffers to one or more other parties 220-280. In other examples, the system 210 may only allow vehicle owners 240 to review lien payoff offers and receive notifications and status updates regarding lien offers, but might not allow vehicle owners 240 to directly submit, accept, or reject offers.

Additionally, as described above, the system 210 may provide functions and user interfaces to allow vehicle owners 240 to receive electronic payments (e.g., insurance payments from insurance companies 220, etc.) and/or to submit electronic payments (e.g., insurance deductible payments to insurance companies 220, lien payments to lienholders 230, etc.). The system 210 may also allow vehicle owners 240 and other users to monitor the status of the lien payoff and title transfer processes for the owner's vehicles, for example, by viewing the online records and/or transactions logs stored at the system 210, and by registering for notifications of events such as the payment of the insurance claim, the release of the lien, and the transfer of the vehicle title. In certain examples, the vehicle owner 240 also may be the title transferee 250, and the system 210 may provide the vehicle owner 240 with the additional functions of title transferee's described below.

Title Transferee 250

For a title transferee user 250, the vehicle title transfer and lien payoff system 210 may provide functions and user interfaces to allow the title transferee 250 to login and retrieve vehicle information (e.g., VIN, license plate, make, model, car, year, etc.), and to retrieve information regarding the vehicle's previous title (e.g., owner name or lienholder name listed on the title). For example, the system 210 may provide the title transferee 250 with a user interface to allow the title transferee 250 to query a system database and/or one or more external databases (e.g., government motor vehicle database) to retrieve the relevant vehicle and title information. Additionally, the system 210 may provide functions and user interfaces to allow the title transferee 250 to input new title information (e.g., title transferee name, address, etc.) which may be stored at the system 210 and/or transmitted to the other parties as needed (e.g., lienholder 230, title holder 280).

The system 210 may also allow title transferees 250 to monitor the status of the lien payoff and title transfer processes for associated vehicles, for example, by viewing the online records and/or transactions logs stored at the system 210, registering for notifications of relevant events (e.g., insurance claim payment, release of the lien), and sending reminders and other communications to other parties (e.g., the lienholder 230 or title holder 280) to facilitate the title transfer. Additionally, the system 210 may provide functions to allow title holders 280 to transfer electronic titles to title transferees 250 (e.g., using a direct electronic title transfer between the parties, or an indirect transfer through the system 210), and to record the sending and receiving of paper titles for vehicles within the system 210.

Governmental Entity 260

For a governmental entity user 260 (e.g., an employee at a state department of motor vehicles (DMV)), the system 210 may provide functions and user interfaces to allow the governmental entity 260 to provide vehicle and title information (e.g., a VIN or license plate number, the legal name on the vehicle title, etc.) that may be required in a lien payoff and title transfer process. Additionally, the system 210 may provide the governmental entity 260 with title transfer information (e.g., title transferee name and address) to allow the governmental entity 260 to record the title transfer in a governmental database. For example, certain states may require that electronic notification of liens are provided to a state governmental entity 260 (e.g., a DMV). Thus, the DMV 260 may register with the system 210 to receive a notification each time a vehicle title is transferred within the jurisdiction of the governmental entity 260.

In certain embodiments, the system 210 also may provide functions and user interfaces to allow governmental entities 260 to determine vehicle registration refunds and provide refunds to vehicle owners 240. For instance, certain governmental jurisdictions may allow for partial refunds of registration fees for vehicles that are totaled during the term of the vehicle registration. In such examples, the system 210 may be configured to inform the governmental entity 260 that the vehicle was totaled, and to provide the date of the accident and vehicle owner information. The system 210 may provide such information to the governmental entity 260 using an automated notification system or as an option in a client application when a governmental entity user logs into the system 210. The system 210 may also provide the functions and user interfaces for the governmental entity 260 to provide an electronic refund payment to the vehicle owner 240, or to record in the system 210 that a paper refund check has been mailed the vehicle owner 240.

Vehicle Dealer 270

As discussed above, during a lien payoff and title transfer process for a totaled vehicle, the vehicle owner 240 may purchase another vehicle from a vehicle dealer 270 to replace the totaled vehicle. In this case, the system 210 may allow a vehicle dealer user 270 to log into the system 210 to confirm that an insurance claim has been paid on the vehicle owner's 240 previous vehicle and that the owner's previous lien has been released by the lienholder 230. In certain examples, the vehicle dealer 270 may register with the system 210 to receive a notification when the lienholder 230 releases the lien on the owner's 240 previous vehicle. Additionally, as described above, the vehicle dealer 270 may also be a lienholder 230 in certain cases. Thus, the system 210 may be configured to provide the vehicle dealer 270 with the additional functions and user interfaces described above for lienholders 230 for vehicles that the system 210 determines have liens held by the vehicle dealer 270.

Title Holder 280

For a title holder user 280, the system 210 may provide functions and user interfaces to allow the title holder 280 to receive instructions to transfer the vehicle title to a designated transferee 250. For example, a title holder 280 may log into the system 210 via a client application, or may register with the system 210 to receive notifications, to confirm that the lienholder 230 has released a vehicle lien, and to receive instructions for the transferring the title to a transferee 250 (e.g., name, address). Additionally, as discussed above, the system 210 may provide functions to allow title holders 280 to transfer electronic titles to title transferees 250 (e.g., using a direct electronic title transfer between the parties, or an indirect transfer through the system 210), or to record into the system 210 the sending and receiving of paper titles.

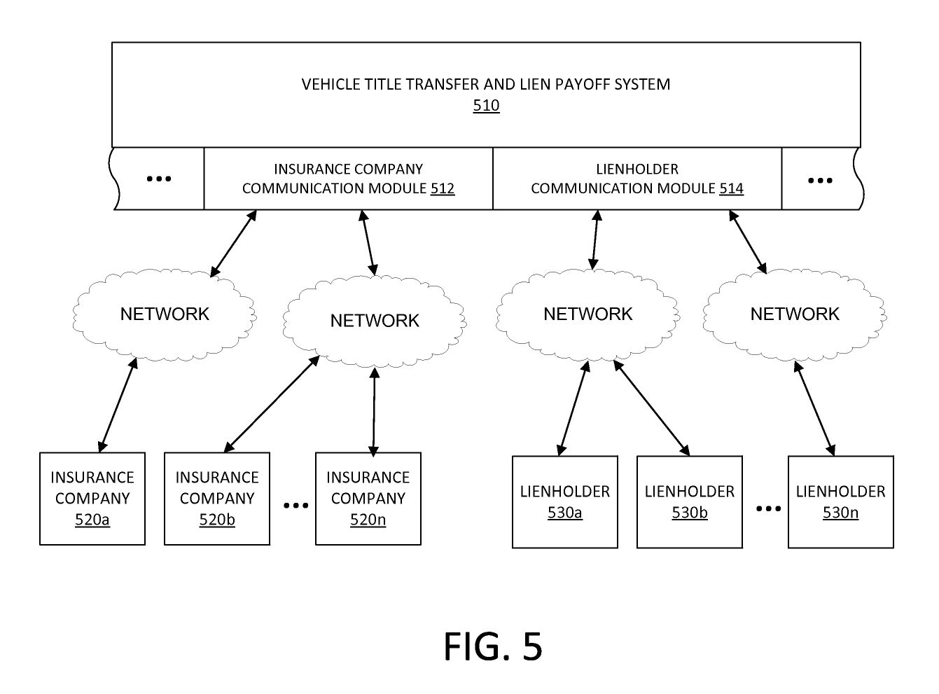

Referring now to FIG. 5, a block diagram is shown illustrating another example of a vehicle title transfer and lien payoff system 510 according to one or more aspects of the disclosure. In this example, the system 510 may be configured to perform some or all of the same functions described above in reference to system 210. Like system 210 described above, the system 510 in this example may be configured to coordinate and perform vehicle lien payoffs and title transfer functions, and to receive and transmit communications between insurance companies 520a-520n, lienholders 530a-530n, and various other parties 220-280 (not shown) involved in lien payoff and title transfer processes.

As shown in FIG. 5, the vehicle title transfer and lien payoff system 510 may include one or more communication modules 512 and 514 configured to communicate with various parties in the lien payoff and title transfer processes. Communication modules 512 and 514 may be implemented using combinations of hardware and software components as described above, and may be designed as separate modules or may be integrated into the system 510. In this example, the insurance company communication module 512 may be configured to communicate with a plurality of different insurance companies 520a-520n, and the lienholder communication module 514 may be configured to communicate with a plurality of lienholders 530a-530n, over one or more different computer networks (e.g., LAN, WAN, or Internet networks, etc.) as well as other communication networks over various media (e.g., wireless networks, telephone networks, cable networks, satellite networks, etc.).

In certain embodiments, a vehicle title transfer and lien payoff system 510 may allow different entities (e.g., insurance companies 520a-520n, lienholders 530a-530n, and other parties 220-280), and different client application users at those entities, to designate different communication techniques/methods and preferences for receiving notifications and interacting with the system 510 and/or other parties 220-280. For instance, in the example shown in FIG. 5, a first insurance company 520a may indicate a first set of communication media and method preferences for receiving lien payoff and title transfer notifications and other communications from the system 510, while a second insurance company 520b may indicate a second set of communication media and method preferences. In certain embodiments, the system 510 may provide functions and user interfaces to different entities to allow those entities to select the communication media and methods that the system 210 will use for communicating with the entity. Additionally, the system 510 may allow for different communication techniques/methods to be used for different types of notifications (e.g., accident report notifications, lien payoff offers and responses, inquiries and communications from other parties 220-280, lien release notifications, title transfer notifications, etc.). For example, a lienholder 530a may elect to receive lien payoff offer notifications from the system 510 via emails sent to a specific set of recipients within the lienholder's organization, but may elect to receive a successful title transfer notification from the system 510 in the form of an update to a database or other shared storage maintained by a different department within the lienholder's organization.

Various entities such as insurance companies 520a-520n, lienholders 530a-530a, and other parties 220-280, as well as the various individual users within those entities, may designate their communication preferences during an initial registration with the system 510 or by logging into the system 510 and modifying the communication preferences for the entity or user. Communication preferences may include communication techniques/methods (e.g., email, phone, SMS messages, instant messaging (IM), etc.) and specific communication recipients (e.g., names, email addresses, phone numbers, IM user identifiers, and the like). Communication preferences may also include updating files, database records, or other shared storage maintained by the system 510 and/or the entity.

Additionally, applying the communication preferences of an entity may include the system 510 interfacing with one or more software applications or services designed and/or operated by the entity. For example, an insurance company 520a (or any other entity involved in a lien payoff or title transfer process) may implement an internal lien payoff and title transfer software application to monitor and track lien payoffs and title transfers for its associated vehicles. In this example, the entity 520a may provide the system 510 with the necessary specifications and instructions (e.g., IP addresses, communication ports and protocols, codes, message formats, etc.) to allow the system 510 to interface with the entity's 520a internal system. The system 510 may save and apply these communication preferences when transmitting future notifications and other communications to the entity 520a.

While the aspects described herein have been discussed with respect to specific examples including various modes of carrying out aspects of the disclosure, those skilled in the art will appreciate that there are numerous variations and permutations of the above described systems and techniques that fall within the spirit and scope of the invention.

1. An apparatus comprising:
a network interface configured to establish communications over a wide area network;
one or more processors; and
at least one memory storing computer readable instructions that, when executed by the one or more processors, cause the apparatus to:
receive, from a first computing device via the network interface, a first user identifier identifying a first user as an insurance company user;
receive, from the first computing device via the network interface, first information for identifying a first vehicle;
retrieve, from a first database based on the first information, data corresponding to at least one of a title transfer process or a lien payoff process for the first vehicle;
determine, based on the first user identifier and a first state of the lien payoff process for the first vehicle, one or more first available functions among a plurality of functions associated with the title transfer process or the lien payoff process for the first vehicle, wherein the first state is an initial state of the lien payoff process and wherein the one or more first available functions include a first function to create a lien payoff offer for the first vehicle;
present, on a display associated with the first computing device, a first user interface with a plurality of options respectively corresponding to the plurality of functions, wherein only first options, corresponding to the one or more first available functions, are selectable;
perform the first function to create the lien payoff offer in response to selection of one of the first options;
query a second database, based on the first function performed, to determine one or more parties with which to initiate communication, the one or more parties including a lienholder of the first vehicle;
communicate, via the network interface, with the one or more parties to provide the one or more parties with information associated with the lien payoff offer for the first vehicle;
receive, from a second computing device via the network interface, a second user identifier identifying a second user as the lienholder;
receive, from the second computing device via the network interface, acceptance data indicating that the lienholder accepts the lien payoff offer;
determine, based on the acceptance data, that the lien payoff process for the first vehicle is in a second state in which the lien payoff offer has been accepted by the lienholder;
determine, based on the first user identifier and the second state of the lien payoff process for the first vehicle, one or more second available functions among the plurality of functions, wherein the one or more second available functions include a second function to submit a payment to the lienholder; and
present, on the display associated with the first computing device, a second user interface with the plurality of options, wherein only second options, corresponding to the one or more second available functions, are selectable.

2-7. (canceled)

8. The apparatus of claim 1, wherein the at least one memory stores further computer readable instructions that, when executed by the one or more processors, cause the apparatus to:
receive, from the lienholder, a counteroffer to the lien payoff offer; and
transmit, to the first computing device, the counteroffer to the lien payoff offer.

9. The apparatus of claim 1, wherein the at least one memory stores further computer readable instructions that, when executed by the one or more processors, cause the apparatus to:
receive an electronic title for the first vehicle from a first party;
determine that one or more title transfer conditions have been satisfied for the first vehicle; and
transmit the electronic title for the first vehicle to a particular party among the one or more parties.

10. The apparatus of claim 1, wherein the at least one memory stores further computer readable instructions that, when executed by the one or more processors, cause the apparatus to:
receive a first electronic funds transfer from a first party; and
transmit a second electronic funds transfer to the lienholder.

11. A method, comprising:
receiving, by a title transfer and lien payoff system having at least one processor, via a network interface configured to establish communications over a wide area network, and from a first computing device, a first user identifier identifying a first user of the title transfer and lien payoff system as an insurance company user;
receiving, by the title transfer and lien payoff system, via the network interface, and from the first computing device, a first vehicle identifier identifying a first vehicle;
retrieving, from a first database based on the first vehicle identifier, data corresponding to at least one of a title transfer process or a lien payoff process for the first vehicle;
determining, based on the first user identifier and a first state of the lien payoff process for the first vehicle, one or more first available functions among a plurality of functions associated with the title transfer process or the lien payoff process for the first vehicle, wherein the first state is an initial state of the lien payoff process and wherein the one or more first available functions include a first function to create a lien payoff offer for the first vehicle;
causing the first computing device to present, on a display associated with the first computing device, a first user interface with a plurality of options respectively corresponding to the plurality of functions, wherein only first options, corresponding to the one or more first available functions, are selectable;
performing, by the title transfer and lien payoff system, the first function to create the lien payoff offer in response to selection of one of the first options;
querying a second database, based on the first function performed, to determine one or more parties with which to initiate communication, the one or more parties including a lienholder of the first vehicle;
communicating, by the title transfer and lien payoff system via the network interface with the one or more parties, information associated with the lien payoff offer for the first vehicle;
receiving, by the title transfer and lien payoff system from a second computing device via the network interface, a second user identifier identifying a second user as the lienholder;
receiving, by the title transfer and lien payoff system from the second computing device via the network interface, acceptance data indicating that the lienholder accepts the lien payoff offer;
determining, based on the acceptance data, that the lien payoff process for the first vehicle is in a second state in which the lien payoff offer has been accepted by the lienholder;
determining, based on the first user identifier and the second state of the lien payoff process for the first vehicle, one or more second available functions among the plurality of functions, wherein the one or more second available functions include a second function to submit a payment to the lienholder; and
causing the first computing device to present, on the display associated with the first computing device, a second user interface with the plurality of options, wherein only second options, corresponding to the one or more second available functions, are selectable.

12-20. (canceled)

21. The apparatus of claim 1,
wherein the first information comprises a vehicle identification number (VIN) received from the first user associated with an insurance provider that insures the first vehicle; and
wherein querying the second database to determine the one or more parties comprises querying a VIN database to determine the lienholder.

22. The apparatus of claim 1,
wherein communicating with the one or more parties comprises:
retrieving, from storage, a first set of communication preferences for an owner of the first vehicle, and a different second set of communication preferences for the lienholder;
initiating communication with the owner in accordance with the first set of communication preferences; and
initiating communication with the lienholder in accordance with the different second set of communication preferences.

23. The apparatus of claim 1, wherein the at least one memory stores further computer readable instructions that, when executed by the one or more processors, cause the apparatus to:
perform a third function to a release of a lien on the first vehicle by the lienholder, and
determine an owner of the first vehicle, a title holder for the first vehicle, or a title transferee for the first vehicle, and
transmit an indication of the release of the lien on the first vehicle to the owner of the first vehicle, the title holder for the first vehicle, or the title transferee for the first vehicle.

24. The apparatus of claim 1, wherein the at least one memory stores further computer readable instructions that, when executed by the one or more processors, cause the apparatus to:
receive a second user identifier identifying a second user;
determine, based on the second user identifier, that the second user is a title holder for the first vehicle; and
in response to determining that the second user is the title holder for the first vehicle, present a third user interface with an option corresponding to a title holder function.

25. The apparatus of claim 24, wherein the at least one memory stores further computer readable instructions that, when executed by the one or more processors, cause the apparatus to:
receive a third user identifier identifying a third user;
determine, based on the third user identifier, that the third user is a title transferee for the first vehicle; and
in response to determining that the third user is the title transferee for the first vehicle, present a fourth user interface with an option corresponding to a title transferee function.

26. The apparatus of claim 25, wherein the at least one memory stores further computer readable instructions that, when executed by the one or more processors, cause the apparatus to:
receive a fourth user identifier identifying a fourth user;
determine that the fourth user is an owner of the first vehicle; and
in response to determining that the fourth user is an owner of the first vehicle, present a fifth user interface with an option corresponding to a vehicle owner function.

27. The apparatus of claim 1,
wherein the first options that are selectable during the first state comprise an option to review lien information and another option to create the lien payoff offer, and
wherein the second options that are selectable during the second state comprise an option to submit the payment to the lienholder and another option to submit a payment to a customer.

28. The apparatus of claim 27, wherein the at least one memory stores further computer readable instructions that, when executed by the one or more processors, cause the apparatus to:
determine, based on the first user identifier and the first state, that a particular function, among the plurality of functions, is not available,
wherein the first user interface comprises a particular option corresponding to the particular function and indicates that the particular option is not selectable by greying out the first option.

29. The apparatus of claim 1, wherein the at least one memory stores further computer readable instructions that, when executed by the one or more processors, cause the apparatus to:
determine, based on a state of the title transfer process for the first vehicle, one or more third available functions including a particular available function for transferring a title of the first vehicle, wherein the state of the title transfer process is a state in which a validity of the title of the first vehicle has been confirmed by an owner of the first vehicle or a government entity.

30. The method of claim 11, further comprising:
determining, based on a second user identifier identifying the lienholder and a third state of the lien payoff process for the first vehicle, one or more third available functions among the plurality of functions, wherein the third state is a state in which the payment to the lienholder has been submitted and wherein the one or more third available functions include a third function for releasing a lien on the first vehicle; and
presenting a third user interface with an option corresponding to the third function; and
in response to selection of the third option, transmitting, to an insurance company associated with the insurance company user, a notification that the lien has been released.

31. A system comprising:
a vehicle owner computing device comprising one or more first processors, a first input device, and a first display device, wherein the one or more first processors are configured to cause the vehicle owner computing device to:
display, on the first display device, a first user interface with one or more first options;
receive, from the first input device while the first user interface is displayed, a first user identifier identifying a first user as a vehicle owner of a vehicle; and
receive, from the first input device, first data indicating that the vehicle has been damaged;
an insurance company computing device comprising one or more second processors, a second input device, and a second display device, wherein the one or more second processors are configured to cause the insurance company computing device to:
determine, based on the first data and a value of the vehicle, that the vehicle is totaled;
transmit, to a vehicle title transfer and lien payoff server, information indicating that the vehicle is totaled;
receive, from the second input device, a second user identifier identifying a second user as an insurance company user;
transmit, to the vehicle title transfer and lien payoff server, the second user identifier;
display, on the second display device, a second user interface;
create, through the second user interface, a lien payoff offer indicating an amount of money to be paid in exchange for releasing a lien on the vehicle;
transmit, to the vehicle title transfer and lien payoff server, the lien payoff offer;
a lienholder computing device comprising one or more third processors, a third input device, and a third display device, wherein the one or more third processors are configured to cause the lienholder computing device to:
receive, from the third input device, a third user identifier identifying a third user as a lienholder for the vehicle;
transmit, to the vehicle title transfer and lien payoff server, the third user identifier;
display, on the third display device, a third user interface; and
generate, through the third user interface, data indicating acceptance of the lien payoff offer;
transmit, to the vehicle title transfer and lien payoff server, the data indicating acceptance of the lien payoff offer for the vehicle;
display, on the third display device, a fourth user interface; and
generate, through the fourth user interface, data for submitting a payment to the lienholder; and
the vehicle title transfer and lien payoff server comprising one or more fourth processors configured to cause the vehicle title transfer and lien payoff server to:
receive, from the insurance company computing device, the information indicating that the vehicle is totaled;
determine, based on the information indicating that the vehicle is totaled, that a lien payoff process for the vehicle is in a first state, wherein the first state is an initial state of the lien payoff process;
receive, from the insurance computing device, the second user identifier identifying the second user as the insurance company user;
determine, based on the second user identifier and the first state, one or more first available functions among a plurality of functions associated with the lien payoff process for the vehicle, wherein the one or more first available functions include a function to create the lien payoff offer;
generate the second user interface with a plurality of second options respectively corresponding to the plurality of functions associated with the lien payoff process for the vehicle, wherein only second options, corresponding to the one or more first available functions, are selectable;
receive, from the insurance computing device, the lien payoff offer for the vehicle;
in response to receiving the lien payoff offer:
transmit, to the lienholder computing device, a notification of the lien payoff offer; and
determine that the lien payoff process for the vehicle is in a second state;
receive, from the lienholder computing device, the third user identifier identifying the third user as the lienholder;
determine, based on the third user identifier and second state, one or more second available functions among the plurality of functions associated with the lien payoff process for the vehicle, wherein the one or more second available functions include a function to accept the lien payoff offer;
generate the third user interface with a plurality of third options respectively corresponding to the plurality of functions associated with the lien payoff process for the vehicle, wherein only third options, corresponding to the one or more second available functions, are selectable;
in response to receiving the data indicating acceptance of the lien payoff offer:
transmit, to the insurance company computing device, a notification of acceptance of the lien payoff offer; and
determine that the lien payoff process for the vehicle is in a third state;
determine, based on the second user identifier and the third state, one or more third available functions among the plurality of functions associated with the lien payoff process for the vehicle, wherein the one or more third available functions include a function to submit the payment to the lienholder; and
generate the fourth user interface with a plurality of fourth options respectively corresponding to the plurality of functions associated with the lien payoff process for the vehicle, wherein only fourth options, corresponding to the one or more third available functions, are selectable.

32. The system of claim 31, wherein the one or more second available functions include a function to make a counteroffer to the lien payoff offer.

33. The system of claim 31, further comprising:
a salvage company computing device;
a title holder computing device; and
a government computing device,
wherein the one or more fourth processors are configured to further cause the vehicle title transfer and lien payoff server to:
receive, from the insurance computing device, an instruction for the lienholder to transfer a title of the vehicle to a salvage company;
transmit, to the lienholder computing device, a notification of the instruction for the lienholder to transfer the title of the vehicle to the salvage company;
receive, from the lienholder computing device, an instruction for a holder of the title of the vehicle to transfer the title;
transmit, to the title holder computing device, a notification of the instruction for the holder of the title of the vehicle to transfer the title;
receive, from the title holder computing device, the title of the vehicle;
transmit, to the salvage company computing device, the title of the vehicle; and
transmit, to the government computing device, registration data to register transfer of the title into a government record database.

34. The system of claim 33,
wherein the vehicle title transfer and lien payoff server comprises memory storing a set of communication preferences for each of the insurance company computing device, the lienholder computing device, the salvage company computing device, the title holder computing device, and the government computing device,
wherein each transmission from the vehicle title transfer and lien payoff server to the insurance company computing device is performed according to the set of communication preferences for the insurance company computing device,
wherein each transmission from the vehicle title transfer and lien payoff server to the lienholder computing device is performed according to the set of communication preferences for the lienholder computing device,
wherein each transmission from the vehicle title transfer and lien payoff server to the salvage company computing device is performed according to the set of communication preferences for the salvage company computing device,
wherein each transmission from the vehicle title transfer and lien payoff server to the title holder computing device is performed according to the set of communication preferences for the title holder computing device, and
wherein each transmission from the vehicle title transfer and lien payoff server to the government computing device is performed according to the set of communication preferences for the government computing device.

35. The method of claim 31, further comprising:
a second lienholder computing device comprising one or more fifth processors, a fourth input device, and a fourth display device, wherein the one or more fifth processors are configured to cause the second lienholder computing device to:
receive, from the fourth input device, a fourth user identifier identifying a fourth user as a second lienholder for a second vehicle; and
display, on the fourth display device, a fifth user interface,
wherein the one or more fourth processors are configured to further cause the vehicle title transfer and lien payoff server to:
determine, based on the fourth user identifier and the third state, that, with respect to the lien on the vehicle, the second lienholder is permitted to only view a status of the lien; and
generate the fifth user interface to display the status of the lien.
